(19) United States
(12) Patent Application Publication
(10) Pub. No.: US 2007/0073889 A1
(43) Pub. Date: Mar. 29, 2007

(54) METHODS, SYSTEMS, AND COMPUTER PROGRAM PRODUCTS FOR VERIFYING AN IDENTITY OF A SERVICE REQUESTER USING PRESENCE INFORMATION

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/162,879

(22) Filed: Sep. 27, 2005

(51) Int. Cl. G06F 15/16

(52) U.S. Cl. 709/229

(57) ABSTRACT

Methods, systems, and computer program products are disclosed for verifying an identity of a service requester using presence information. A request for service is received from a service requester via a service client at a service provider. The request includes an identifier for identifying presence information for the service requester. The service provider communicates with a presence service associated with the identified presence information for verifying an identity of the service requester based on the presence information.

### BACKGROUND

Many transactions today require some form of authentication, including verification of the identity of a participant to the transaction. For example, a purchase made at a bricks-and-mortar retail store may require a purchaser to show some form of identification. Purchases made online at an e-commerce web site may also require some form of verification, such as a username and password. In the above scenarios, the bricks-and-mortar retail store and the e-commerce web site operator may be referred to as a service provider and the purchaser may be referred to as a service requester. These terms however are not limited to purchases between a buyer and a seller and may represent other transactions.

With the growing epidemic of identity theft and the growing number of fraudulent transactions in general, conventional methods of identity verification often fall short. New and/or supplementary methods of verifying a user's identity can prevent many of these criminal activities. For example, a service requester's presence information may be used to verify an identity of the user according to an aspect of the subject matter described herein.

Accordingly, there exists a need for methods, systems, and computer products for verifying an identity of a service requester using presence information.

### SUMMARY

In one aspect of the subject matter disclosed herein, a method at a service provider for verifying an identity of a service requester using presence information includes receiving a request for service from service requester via a service client. The request includes an identifier for identifying presence information for the service requester. The service provider communicates with a presence service associated with the identified presence information for verifying an identity of the service requester based on the presence information.

In another aspect of the subject matter disclosed herein, a method at a presence service for verifying an identity of a service requester using presence information includes receiving a subscribe message from a service provider for subscribing to presence information for a service requester and sending a notify message to a service client associated with the service requester. The notify message indicates that the subscribe message has been received. A publish message is received from the service client, the publish message indicating an authorization for providing the presence information to the service provider. The presence service determines whether to send a notify message including the presence information to the service provider based on the indicated authorization and sends the notify message based on the determination.

In another aspect of the subject matter disclosed herein, a method at a presence service for verifying an identity of a service requester using presence information includes receiving a publish message from a service client requesting service for a service requester from a service provider. The publish message includes an identifier for correlating a request for service to presence information for the service requester. A notify message is sent to the service provider including the identifier and presence information for the service requester.

In another aspect of the subject matter disclosed herein, a method at a presence service for verifying an identity of a service requester using presence information includes receiving a publish message including information about a request for service made by a service requester, determining, based on the information about the request for service, whether an identity of the service requester is verified, and sending a notify message to the service provider that indicates a result of the verification determination.

In another aspect of the subject matter disclosed herein, a system for verifying, at a service provider, an identity of a service requester using presence information includes means for communicating with a service client and with a presence service; means for processing a request for service received from a service requester via the service client, the request including an identifier for identifying presence information for the service requester; and means for communicating with a presence service associated with the identified presence information for verifying an identity of the service requester based on the presence information.

In another aspect of the subject matter disclosed herein, a system for verifying, at a service provider, an identity of a service requester using presence information includes a network interface configured for communicating with a service client and with a presence service; a service client interface component configured for processing a request for service received from a service requester via the service client, the request including an identifier for identifying presence information for the service requester; and a presence verification component configured for communicating with a presence service associated with the identified presence information for verifying an identity of the service requester based on the presence information.

In another aspect of the subject matter disclosed herein, a system for verifying an identity of a service requester using presence information at a presence service includes means for communicating with a service client and with a service provider; means for processing a subscribe message from the service provider for subscribing to presence information for a service requester associated with the service client, for sending a notify message to notify the service client that the subscribe message has been received, for receiving a publish message from the service client that indicates an authorization for providing the presence information to the service provider, and for sending a corresponding notify message with the presence information to the service provider; and means for processing the received publish message to determine whether to send the notify message with the presence information to the service provider based on the indicated authorization.

In another aspect of the subject matter disclosed herein, a system for verifying an identity of a service requester using presence information at a presence service includes a network interface configured for communicating with a service client and with a service provider; a notification component configured for processing a subscribe message from the service provider for subscribing to presence information for a service requester associated with the service client, for sending a notify message to notify the service client that the subscribe message has been received, for receiving a publish message from the service client that indicates an authorization for providing the presence information to the service provider, and for sending a corresponding notify message with the presence information to the service provider; and a verification component configured for processing the received publish message to determine whether to send the notify message with the presence information to the service provider based on the indicated authorization.

In another aspect of the subject matter disclosed herein, a system for verifying an identity of a service requester using presence information at a presence service includes means for communicating with a service client and with a service provider; means for receiving a publish message from the service client, the publish message including an identifier for correlating a request for service to presence information for a service requester; and means for sending a notify message to the service provider including the identifier and presence information for the service request.

In another aspect of the subject matter disclosed herein, a system for verifying an identity of a service requester using presence information at a presence service includes a network interface configured for communicating with a service client and with a service provider; a publish component configured for receiving a publish message from the service client, the publish message including an identifier for correlating a request for service to presence information for the service requester; and a notification component configured for sending a notify message to the service provider including the identifier and presence information for the service requester.

In another aspect of the subject matter disclosed herein, a system for verifying an identity of a service requester using presence information at a presence service includes means for communicating with a service client and with a service provider; means for processing a publish message received from the service provider that includes information about a request for service made by a service requester and for sending a corresponding notify message to the service provider with a verification indication; and means for determining the verification indication based on the information about the request for service, the verification indication indicating whether an identity of the service requester is verified.

In another aspect of the subject matter disclosed herein, a system for verifying an identity of a service requester using presence information at a presence service includes network interface configured for communicating with a service client and with a service provider; a publish component configured for processing a publish message received from the service provider that includes information about a request for service made by a service requester and for sending a corresponding notify message to the service provider with a verification indication; and a verification component configured for determining the verification indication based on the information about the request for service, the verification indication indicating whether an identity of the service requester is verified.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 illustrates an arrangement for verifying an identity of a service requester using presence information according to an aspect of the subject matter disclosed herein;

FIGS. 2-6 are signaling diagrams illustrating different signaling scenarios according to different aspects of the subject matter disclosed herein;

FIG. 7 is a block diagram illustrating presence functionality that may be incorporated into communication components to enable presence protocol communications with the presence service by the service provider and service client;

FIG. 8 is a flow diagram illustrating a method at a service provider for verifying an identity of a service requester using presence information according to an aspect of the subject matter disclosed herein;

FIG. 9 is a flow diagram illustrating a method at a presence service for verifying an identity of a service requester using presence information according to another aspect of the subject matter disclosed herein;

FIG. 10 is a flow diagram illustrating a method at a presence service for verifying an identity of a service requester using presence information according to another aspect of the subject matter disclosed; and

FIG. 11 is a flow diagram illustrating a method at a presence service for verifying an identity of a service requester using presence information according to another aspect of the subject matter disclosed.

### DETAILED DESCRIPTION

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Thus, the subject matter described herein can be embodied in many different forms, and all such forms are contemplated to be within the scope of what is claimed.

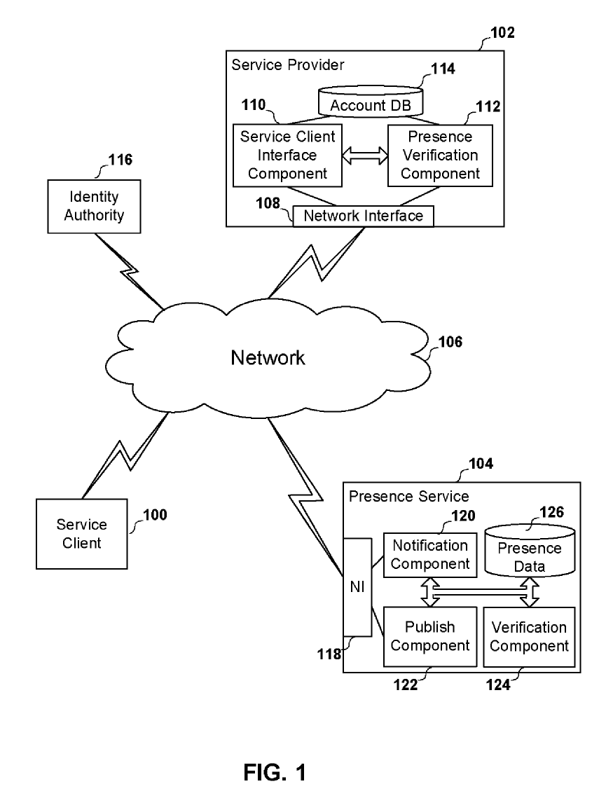

FIG. 1 illustrates an arrangement for verifying an identity of a service requester using presence information according to an aspect of the subject matter disclosed herein. In FIG. 1, a service client 100, a service provider 102, and a presence service 104 can communicate via a network 106, such as the Internet, a local area network, a wide area network, and the like. The service client 100 may be associated with a client device (not shown), such as a personal computer, mobile telephone, personal digital assistant, or other electronic device. The service client 100 may include a client application for communicating with the service provider 102 using any known communication protocol. For example, the service client 100 may include a browser such as MICROSOFT INTERNET EXPLORER or MOZILLA FIREFOX for communicating with the service provider 102 via an HTTP protocol.

The service provider 102 may be, for example, a shopping service, a payment service, a banking service, a shipping service, or any other known service provider. According to one aspect, the service client 100 may be a device and/or application operated by a user for requesting service from the service provider 102. For example, the service client 100 may be a browser communicating with a server hosting an e-commerce web site for the service provider 102. A user navigates to the web site and requests service from the service provider 102. In this case, the user becomes a service requester and the service provided by the service provider 102 is providing items for purchase to the user via the service client 100.

According to another aspect, the service client 100 may be a device and/or application used at a point of sale to receive a request for service from a user/service requester. For example, service client 100 may be a device and/or application operable as part of, or in conjunction with, a cash register operated by a store clerk at a brick-and-mortar retail store when processing a transaction for a user. In such a case, the user is still considered the service requester, since the user is requesting service from the service provider, i.e., requesting to purchase an item for sale.

In operation, the service client 100 sends a request for service to the service provider 102. For example, service client 100 may a send service request including information provided by a user either directly, i.e., filling out a form on the service provider's e-commerce web site, or indirectly through a store clerk. For example, in order for a user to purchase an item on an e-commerce web site, the user may be required to provide such information as name, address, telephone number, payment information such as credit card numbers, and other information.

In order to verify some aspect of the transaction, such as the user's identity, a user may conventionally be required to provide a username and password. In the brick-and-mortar example, a user may conventionally be required to provide some form of ID to the store clerk. Clearly these verification precautions have been inadequate given the level of fraudulent transactions, identity theft, and other unauthorized service requests perpetrated today.

According to aspects of the subject matter disclosed herein, presence information is used to verify an identity of a service requester. The architecture, models, and protocols associated with presence services in general are described in “Request for Comments” (or RFC) documents RFC 2778 to Day et al., titled “A Model for Presence and Instant Messaging” (February 2000), and RFC 2779 to Day et al., titled “Instant Messaging/Presence Protocol” (February 2000), each published and owned by the Internet Society.

Presence information includes the status of a user of the presence service and may include additional information. Presence information can be stored or maintained in any form for use by the presence service 104, but typically is organized into portions referred to as presence tuples. As will be understood by those skilled in the art, a tuple, in its broadest sense, is a data object containing one or more components. Thus, a presence tuple can include an identifier of a user and the user's status, contact address, or other information used by the presence service. If the current status doesn't match the context of the current request, the request can be denied. Similarly, presence information may contain location. If a user is making a request at location A while the user's presence information indicates he or she is in some other location, the request may be fraudulent. Presence information may also contain contact addresses with priorities, which can be checked against information provided by the user and/or the location from which the service request originated.

Since presence tuples are extendible, additional information may be added which can further serve to verify a service requester's identity and authority. For example, a presence tuple may contain information regarding agents who may act on behalf of the service requester and the activities they are allowed to perform in this role. It should be understood, therefore, that presence information may contain multiple status values that can be broad indicators and/or precise indicators of the service requester's presence.

The service provider 102 may try to obtain verification for status values that are specific to the type of request being made. For example, a badge reader at a work site might use the location in the presence information to verify that the person presenting the badge is at the location of the badge reader. A bricks-and-mortar store processing a credit card charge for a customer might not be interested in a service requester's general status (i.e., “stepped out”), but may rely on one or more activity status that indicates “shopping” and the service requester's location. An online bank may look for an activity status of “banking” and may verify that the IP address from which the request originated is assigned to a device in the general area that the service requester's location information indicates. If the service requester's general status is “offline” then no online requests would be verified.

In another example, a service requester can use a status field in the service requester's presence information to report a credit card status as “lost credit card” before officially reporting the card lost to the credit card issuer, if the user thinks the card was misplaced. If the card is found later, the status is simply changed without the user having to go through the hassle of canceling the card and having a new one issued.

Presence service 104 may include one or more presence servers used to provide presence services. The function of the presence server, however, can be incorporated, either in whole or in part, into any of the service client 100, the service provider 102, and/or the presence service 104. The presence service model described in RFC 2778 describes two distinct agents of a presence service client. The first of these agents, called a “presentity” (combining the terms “presence” and “entity”), provides presence information to be stored and distributed throughout the presence service on behalf of a presence client. The second type of presence agent is referred to as a “watcher”. Watchers receive presence information from the presence service 104 on behalf of a presence client. The presence model of RFC 2778 describes types of watchers, referred to as “subscribers” and “fetchers”. A subscriber requests notification from the presence service 104 of a change in some presentity client's presence information. The presence service 104 establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher. A special kind of fetcher, referred to as a “poller”, is defined in the model that fetches information on a regular (or polling) basis.

The presence service 104 can also manage, store, and distribute presence information associated with watcher clients through their presentities, as well as the watcher clients' activities in terms of the fetching or subscribing to the presence information of other presence clients using the presence service. This “watcher activity information” can be distributed to other watcher clients by the presence service 104 using the same mechanisms that are available for distributing the presence information of presentity clients.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers. The term presence client is used to refer to principals or their agents and will be clear from the context in which the term is used.

With reference again to FIG. 1, some or all of the communications exchanged between the service client 100, the service provider 102, and/or the presence service 104 can be carried out using a presence protocol. Generally, in a presence protocol, senders of information (or publishers) publish messages with information. The information is stored in one or more presence tuples, which may be stored as presence data in a database 126 at presence service 104. Parties interested in receiving the information send a subscribe message to the presence service 104 and may be referred to as subscribers. The presence service 104 then selectively broadcasts the published information using what are referred to as notify messages to all subscribers. The published information can be received simultaneously by any number of subscribers.

While the embodiments illustrated herein use a presence service by way of example, alternate embodiments may be employed that use a more general purpose publish/subscribe (pub/sub) server. In either case, the presence service and/or the pub/sub service may include presence information that includes a presence tuple having a presence status field associated with a service requester or client with which the tuple is associated. Alternatively, the presence status field may be omitted without departing from the subject matter described herein.

It should also be understood that, as used herein, the term “presence information” may include a location and/or activity associated with a service requester. In the presence model RFC 2778, status is defined as a distinguished part of presence information of a presentity. More particularly, RFC 2778 defines statuses of open and closed for use in instant messaging and other forms of communication. A status of open, for example, can indicate availability to receive communications (such as IM messages and may include any other forms of communications), while closed can be used to indicate unavaillability. RFC 2778 also provides for status to include other values, which may consist of single or multiple values. For example, as described above, status can include information about a location associated with the service requester and/or information about an activity associated with the service requester. That is, status can include only information about a location associated with the service requester. For example, a status can be “at home”, “at the mall”, “at the movies”, “not at the mall”, “not at a computer”, and the like. Status can include only information about an activity associated with the service requester. For example, a status can be “shopping”, “not shopping”, “online”, “not online”, and the like. Status can also include both activity and location information. Status can be very specific or broad. For example, status can provide information about a single account, such as a credit card account, for a service requester, or universally for all accounts. An example of statuses specific to an account is “shopping with Visa credit card” or “not shopping with Visa credit card.”

Accordingly, status may include forms and values not specifically mentioned in the presence model while omitting forms and values that are specifically mentioned, while staying within the model described in RFC 2778. It should therefore be understood that presence information, as used herein, is intended to cover all forms and values of status specifically mentioned in RFC 2778 and those not specifically mentioned.

In FIG. 1, the service provider 102 includes a system for verifying an identity of a service requester using presence information. The service provider 102 includes means for communicating with a service client and with a presence service. For example, the service provider 102 includes a network interface 108 configured for communicating with the service client 100 and with the presence service 104 using any known protocol or protocols. For example, the network interface 108 may include network services for communicating with the service client 100 using a hypertext transport protocol (HTTP) and with the presence server 104 using a presence protocol.

The service provider 102 also includes means for processing a request for service received from the service client 100, where the request includes an identifier for identifying presence information for the service requester. For example, the service provider 102 can include a service client interface component 110 configured for processing a request for service received from the service client. The service client interface component 110 is capable of processing requests for service from the service client 100 received via any known protocol at network interface 108.

The request includes an identifier for identifying presence information for the service requester. According to one aspect, the request includes a universal resource indicator (URI), such as a universal resource locator (URL), to identify presence information for the service requester at presence service 104. For example, the request may include a form submission from a browser at service client 100 that includes a URL that identifies an address that defines the route to the presence service 104. URL's typically contain a protocol prefix (such as http:), the port number, domain name, subdirectory name, and file name. If a port number is not stated in the address, a default port is used. For example, port 80 is used as the default port for HTTP traffic. URL's are not limited to identifying HTTP resources and may be used to identify other resources.

According to another aspect, the request may additionally, or alternatively, include an identifier for correlating the request to presence information for the service requester. For example, the request may include an identifier that identifies a message to be received (or already received) from the presence service 104. The presence service message includes the same identifier, and can therefore be correlated to the request for service. As will be appreciated by one of ordinary skill in this art, a correlation between the request for service and a message received from a presence service may be accomplished using various other techniques. It should therefore be understood that any known technique for correlating requests with messages may be used according to the subject matter described herein.

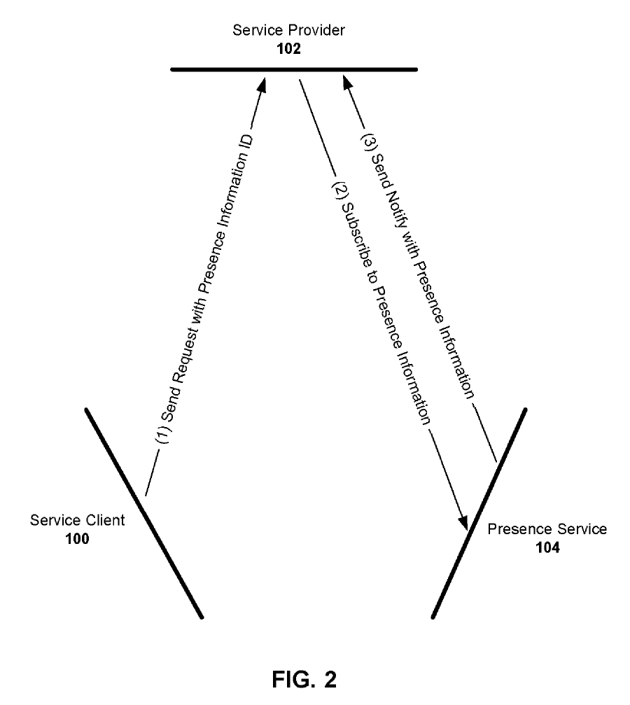

The service provider 102 also includes means for communicating with a presence service associated with the identified presence information for verifying an identity of the service requester. For example, the service provider 102 may include a presence verification component 112 configured for communicating with the presence service 104 associated with the identified presence information for verifying an identity of the service requester based on the presence information, as will be discussed further below in connection with FIGS. 2-6.

To verify a service requester's identity, information about the request for service can be compared to the service requester's presence information. The information about the request for service can include information about a location associated with the request for service (e.g., area associated with an IP address the request originates from, a brick-and-mortar store address, etc.) and/or information about an activity associated with the request for service (e.g., online, banking, shopping, etc.). For online transactions, the service provider can determine an area associated with an IP address the request originates from by checking with a database mapping IP addresses to geographical location information. The database may be maintained by the service provider or access by the service provider and maintained by a third-party.

The information about the request for service can also include a certificate verifying an identity of the service provider 102 to the presence service 104. Referring to FIG. 1, an identity authority 116 may issue a token or certificate to the service provider 102 to authenticate the service provider's identity to the presence service 104 and/or to the service client 100 during communications. Similarly, service client 100 or the presence service may obtain a token or certificate issued by the identity authority 116 to confirm their identity to the other respective entities during communications. The identity authority 116 may be, for instance, a certificate authority such as VERISIGN or THAWTE.

The service provider 102 may also include an account database 114 for storing and managing customer account information. The management of customer account information can include the management of service information about service requests and/or presence information for service requesters.

According to another aspect, the presence service 104 includes a system for verifying an identity of a service requester using presence information. As illustrated in FIG. 1, the presence service 104 includes means for communicating with a service client and with a service provider. For example, presence service 104 can include a network interface 118 configured for communicating with the service client 100 and with the service provider 102 using a presence protocol.

The presence service 104 includes a notification component 128, a publish component 122, a verification component 124, and the presence data 126, each of which are discussed below in connection with FIGS. 2-5.

FIGS. 2-6 are signaling diagrams illustrating different signaling scenarios according to different aspects of the subject matter disclosed herein. In FIG. 2, the service client 100 sends a request to the service provider 102 that includes an identifier identifying the presence information. For example, the request may include a URL identifying the presence service 104 and a presence tuple for the service requester. The service provider 102, using the identifier, subscribes to the service requester's presence tuple at the presence service 104. The presence service 104 responds by sending a notify message including the presence information to the service provider 102. Here, the verification component 124 of the presence service 104 may perform some level of authorization to determine whether the service provider 102 is authorized to receive the presence information. For example, the verification component 124 can check a certificate provided by the service provider 102 to authenticate its identity to the presence service 104. Alternatively, the service provider 102 may be required to provide a password for authentication. The verification component 124 can check the service requester's presence tuple to determine if this particular service provider has been pre-authorized for receiving presence information.

According to the aspect illustrated in FIG. 2, the presence verification component 112 at the service provider 102 is configured to communicate with the presence service 104 associated with the identified presence information for verifying an identity of the service requester by subscribing to a presence tuple associated with the service requester, for receiving one or more notification messages including presence information for the service requester, and for processing the one or more notification messages to verify an identity of the service requester based on the presence information. The presence service 104 includes means for processing the subscribe message from the service provider 102 and for sending a corresponding notify message with the presence information to the service provider 102. For example, the notification component 1 20 may be configured for performing these functions.

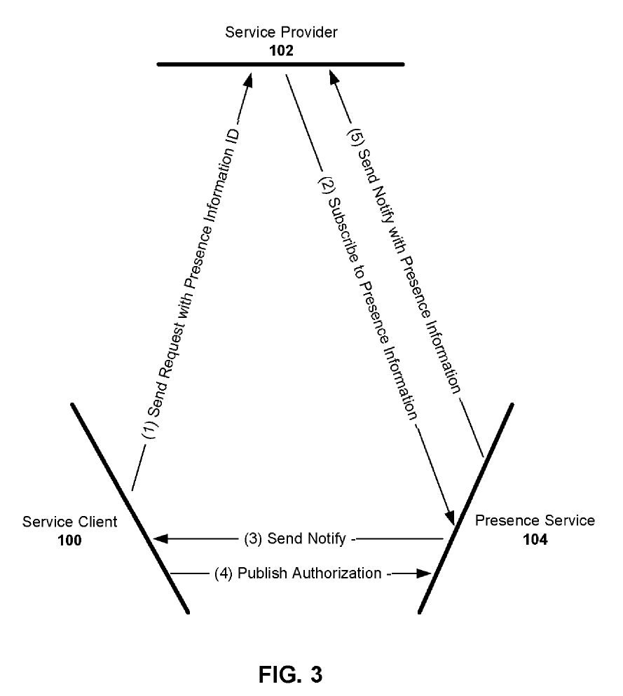

In FIG. 3, the service client 100 sends a request to the service provider 102 that includes an identifier identifying the presence information. The service provider 102, using the identifier, subscribes to the service requester's presence tuple at the presence service 104. The presence service 104 sends a notify message to the service client 100 for requesting authorization to provide the service provider 102 with the presence information. The notify message can include information identifying the service provider 102. The service client 100 publishes an authorization to the service requester's presence tuple at the presence service 104. The presence service 104 responds by sending or not sending, based on the authorization, a notify message including the presence information to the service provider 102.

According to this aspect, the service client 100 is given an opportunity to authorize the release of presence information to the service provider 102. For example, the service client 100 may be a browser operated by the service requester and may present a message to the service requester indicating that the service provider 102 has requested presence information and may provide detailed information about a transaction, such as a credit card used, location, etc. The service requester can then decide whether to authorize the sending of presence information to the service provider by responding to the message prompt. The service requester's response results in a generation of a publish message with the authorization.

According to another aspect, verification component 124 in presence service 104 can perform a preliminary authorization check and can send the notify message to the service client 100 only when authorization at the presence service has failed. This gives the service client 100 the opportunity to override the verification component 124 and authorize the presence service 104 to provide presence information to the service provider 102.

According to the aspect illustrated in FIG. 3, the presence verification component 112 at the service provider 102 is configured to communicate with the presence service 104 associated with the identified presence information for verifying an identity of the service requester by subscribing to a presence tuple associated with the service requester, receiving one or more notification messages including presence information for the service requester, and processing the notification messages to verify an identity of the service requester based on the presence information.

Also according to the aspect illustrated in FIG. 3, the presence service 104 includes means for processing the subscribe message from the service provider 102 for subscribing to presence information for a service requester associated with the service client 100, for sending a notify message to notify the service client 100 that the subscribe message has been received, for receiving a publish message from the service client 100 that indicates an authorization for providing the presence information to the service provider 102 , and for sending a corresponding notify message with the presence information to the service provider 102. For example, presence service 104 may include a notification component configured for performing these functions. The presence service 104 also includes means for processing the received publish message to determine whether to send the notify message with the presence information to the service provider based on the indicated authorization. For example, the presence service may include the verification component 124 configured for processing the received publish message to determine whether to send the notify message with the presence information to the service provider based on the indicated authorization.

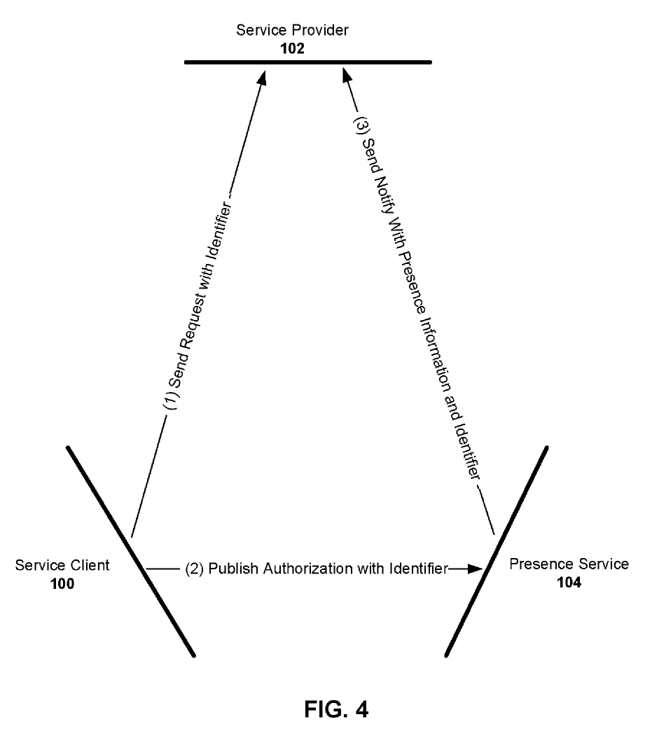

FIG. 4, the service client 100 sends a request with the identifier to the service provider 102. The service client 100 also sends an authorization message with the identifier to the presence service 104. The presence service 104 provides the requested presence information in a notify message identified by the identifier to the service provider 102. As discussed above, the identifier may be any identifier or other means that can be used for correlating the request for service with the provided notify message at the service provider 102.

According to the aspect illustrated in FIG. 4, the presence verification component 112 at the service provider 102 is configured to communicate with the presence service 104 associated with the identified presence information for verifying an identity of the service requester by receiving one or more notification messages including presence information for the service requester and an identifier, correlating the one or more notification messages to the request for service based on the identifier, and processing the one or more notification messages to verify an identity of the service requester based on the received presence information.

Also according to the aspect illustrated in FIG. 4, the presence service 104 includes means for receiving a publish message from the service client. For example, the publish component 122 can be configured for receiving a publish message from the service client. The publish message includes an identifier for correlating a request for service to presence information for the service requester. The presence service 104 also includes means for sending a notify message to the service provider including the identifier and presence information for the service requester. For example, the notification component 120 may be configured for sending a notify message to the service provider including the identifier and presence information for the service requester.

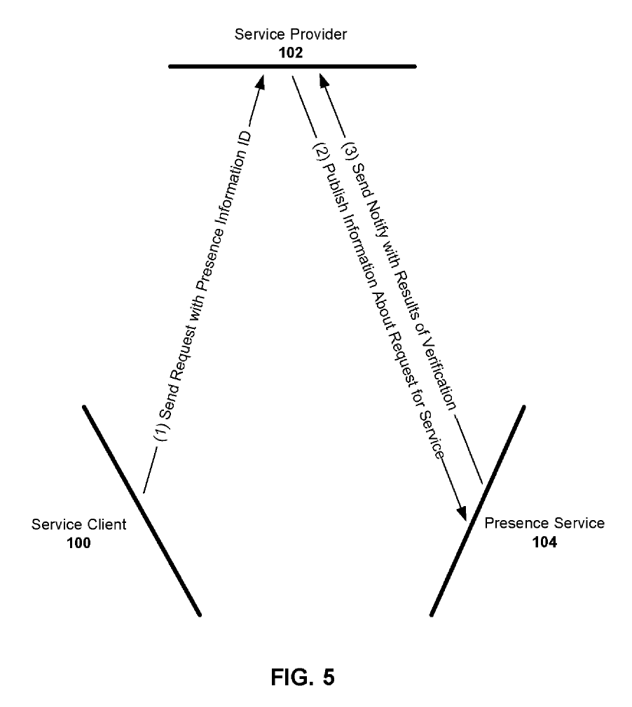

In FIG. 5, the service client 100 sends a request with the identifier to the service provider 102. The service provider sends a publish message to the publish component 122 of the presence service 104. The publish message includes information about the request for service. For example, the information about the request for service can include information about a location associated with the request for service and/or information about an activity associated with the request for service, as described above. The request for service may also include a certificate verifying an identity of the service provider to the presence service 104. The verification component 124 compares the information about the request for service to presence information associated with the service requester and determines, based on the comparison, whether an identity of the service requester is verified. The presence information associated with the service requester can include information about a location associated with the service requester and/or information about an activity associated with the service requester. The presence service 104 sends a notify message to the service provider with an indication as to the results of the verification. For example, the indication could be verified or not verified.

According to the aspect illustrated in FIG. 5, the presence service 104 includes means for processing a publish message received from the service provider that includes information about a request for service made by a service requester and for sending a corresponding notify message to the service provider with a verification indication. For example, the publish component 122 may be configured for processing a publish message received from the service provider and the notification component 120 may be configured for sending a corresponding notify message to the service provider with a verification indication. The presence service 104 also includes means for determining the verification indication based on the information about the request for service, the verification indication indicating whether an identity of the service requester is verified. For example, the verification component can be configured for determining the verification indication based on the information about the request for service.

Also according to the aspect illustrated in FIG. 5, the presence verification component 112 of the service provider 102 is configured to communicate with the presence service 104 associated with the identified presence information for verifying an identity of the service requester by publishing information about the request for service to the presence service 104, for receiving one or more notification messages indicating whether the identity of the service requester is verified, and for processing the one or more notification messages to verify an identity of the service requester based on the received indication.

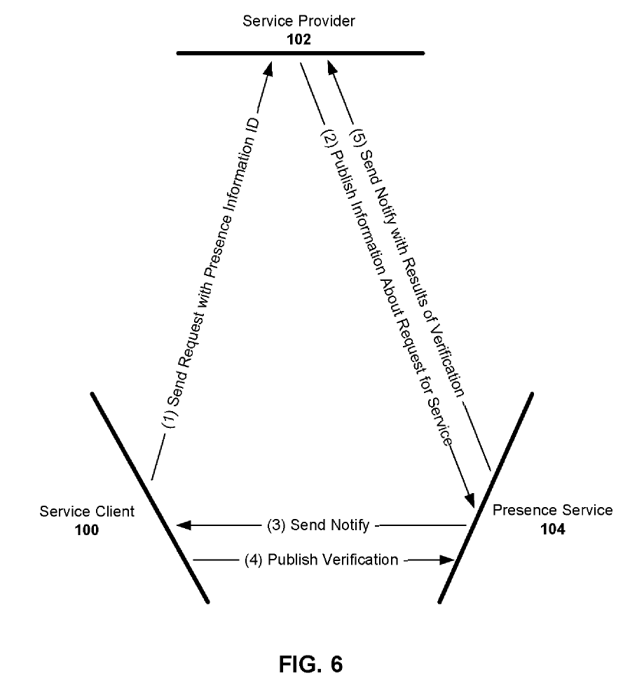

In FIG. 6, the service provider 102 and presence service 104 perform similar functions described above with reference to FIG. 5, but provide for additional functionality for receiving authorization from service client 100. The verification component 124 of the presence service 104, upon receiving the publish message from the service provider 102, sends a notify message to the service client 100 providing information about the request for verification. The service client 100 publishes an authorization to the service requester's presence tuple at the presence service 104. The presence service 104 responds by sending, based on the authorization, a notify message including the presence information to the service provider 102.

According to this aspect, the service client 100 is given an opportunity to provide or deny verification of identity to the service provider 102. For example, the service client 100 may be a browser operated by the service requester and may present a message to the service requester indicating that the service provider 102 has requested presence information and may provide detailed information about a transaction, such as a credit card used, location, name, etc. The service requester can then decide whether to verify the identity by responding to the message prompt. The service requester's response results in a generation of a publish message with the authorization.

According to another aspect, the verification component 124 in presence service 104 can perform a preliminary identity verification and can send the notify message to the service client 100 only when the verification at the presence service 104 has failed. This gives the service client 100 the opportunity to override the verification component 124 and verify identity to the service provider 102. For example, suppose a user lends his credit card to someone who then goes shopping without the user but with the user's permission. The verification procedure at the presence service 104 would fail because the user's presence location would be different than the brick-and-mortar store that the transaction is occurring at. Instead of automatically denying verification, the verification component 124 can check with the user at service client 100, who can then provide verification for the transaction.

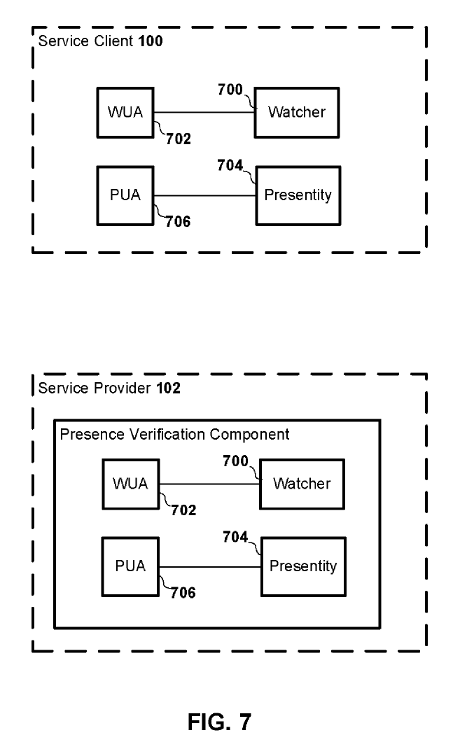

FIG. 7 is a block diagram illustrating presence functionality that may be incorporated into communication components to enable presence protocol communications with the presence service 104 by the service provider 102 and service client 100. In FIG. 7, the service client 100 includes a watcher 700 configured to request a subscription to a tuple and an associated WUA 702 configured to receive an identifier for the tuple entered by a user (e.g. via an entry in a user interface (not shown), for example). The WUA 702 can pass the identifier to the watcher 700, which then requests the subscription to the tuple. The tuple is stored at the presence service 104 in the presence data database 126. The watcher 700 can send the request for a subscription to the tuple to the presence service 104, which is processed by the notification component 120. The notification component 120 is configured to respond by sending notifications to the watcher client 700 of the service client 100 pursuant to the subscription.

The service client 100 can also include a presentity 704 and an associated PUA 706. The presentity/PUA 704, 706 can be configured to publish changes to the presence information to the tuple at the presence service 104. The publish component 122 at the presence service 104 is configured to process the publish messages and update the tuple accordingly. For example, the presentity/PUA 704, 706 can be configured to publish authorization as shown in FIG. 3 or verification as shown in FIG. 6.

The presence verification component 112 at the service provider 102 may also include a watcher 700 and a WUA 702. The watcher/WUA 700, 702 can be configured for subscribing to a tuple containing presence information at the presence service 104 for receiving notifications including the presence information as illustrated in FIGS. 2-4 or for receiving notifications including a verification as illustrated in FIGS. 5 and 6.

The presence verification component 112 can also include a presentity 704 and an associated PUA 706. The presentity/PUA 704, 706 can be configured to publish information about the request for service to the tuple at the presence service 104 as shown in FIGS. 5 and 6. The publish component 122 at the presence service 104 is configured to process the publish messages and update the tuple accordingly.

One skilled in this art will observe that the names of the components described above correspond to the components of the presence model defined in RFC 2778 to Day et al., titled “A Model for Presence and Instant Messaging” (IETF, February 2000). It should be understood that the described functions, namely the publish, notify, and subscribe functions, can be incorporated as defined in RFC 2778 including any variations and/or modifications known to one of ordinary skill in this art.

It should also be understood that communications between the service client 100, the service provider 102, and the presence service 104 are not necessarily limited to a presence protocol and may be carried out using any known communication protocol. For example, requests for service can be made using HTTP requests and responses. Requests can be made using the HTTP Get or Post method. The HTTP Post method is particularly useful for form submissions to a web server. For example, an HTTP Post can be used to submit a form by the service client 100 to the service provider 102. HTTP also includes several other request methods, such as a Get method, as well as response messages that are suitable to carry out the subject matter described herein. Other protocols may also be employed.

It should further be understood that the various components illustrated in the Figures represent logical components that are configured to perform the functionality described herein and may be implemented in software, hardware, or a combination of the two. Moreover, some or all of these logical components may be combined and some may be omitted altogether while still achieving the functionality described herein.

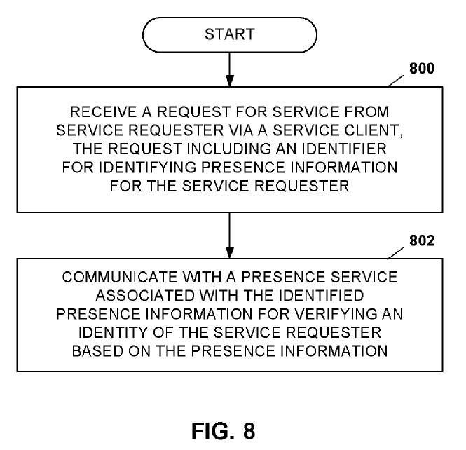

FIG. 8 is a flow diagram illustrating a method at a service provider for verifying an identity of a service requester using presence information according to an aspect of the subject matter disclosed herein. In block 800, a request for service is received from service requester via the service client 100. The request includes an identifier for identifying presence information for the service requester. For example, the request may include a URI identifying presence information at presence service 104. The identifier may, alternatively or in addition, provide a correlation between the request for service and the presence information. In block 802, the service provider 102 communicates with the presence service 104 associated with the identified presence information for verifying an identity of the service requester based on the presence information. For example, according to one aspect, the service provider 102 can subscribe to a presence tuple associated with the service requester, receive one or more notification messages including presence information for the service requester, and process the notification messages to verify an identity of the service requester based on the presence information.

According to another aspect, the service provider 102 can receive one or more notification messages including presence information for the service requester and the identifier, correlate the at least one notification message to the request for service based on the identifier, and process the notification messages to verify an identity of the service requester based on the received presence information.

According to another aspect, the service provider 102 can publish information about the request for service to the presence service, receive one or more notification messages indicating whether the identity of the service requester is verified, and process the at least one notification message to verify an identity of the service requester based on the received indication. As discussed above, the information about the request for service can include, for example, information about a location associated with the request for service and/or information about an activity associated with the request for service.

According to another aspect, the service provider 102 can also provide a certificate verifying an identity of the service provider to the presence service.

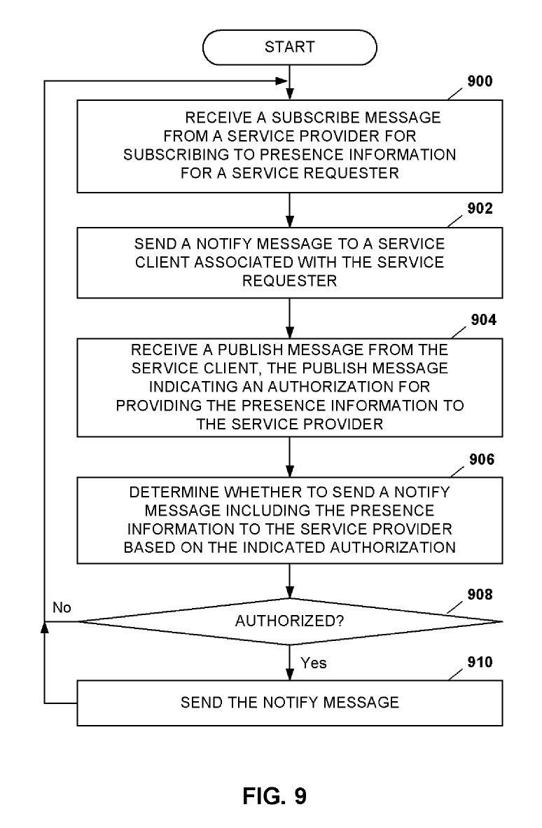

FIG. 9 is a flow diagram illustrating a method at a presence service for verifying an identity of a service requester using presence information according to another aspect of the subject matter disclosed herein. In block 900, a subscribe message is received from the service provider 102 for subscribing to presence information for a service requester. A notify message is sent to the service client 100 associated with the service requester in block 902. The notify message indicates that the subscribe message has been received. A publish message is received from the service client 100 in block 904. The publish message indicates an authorization for providing the presence information to the service provider. The presence service 104 determines in blocks 906 and 908 whether to send a notify message including the presence information to the service provider based on the indicated authorization and sends the notify message based on the determination in block 910.

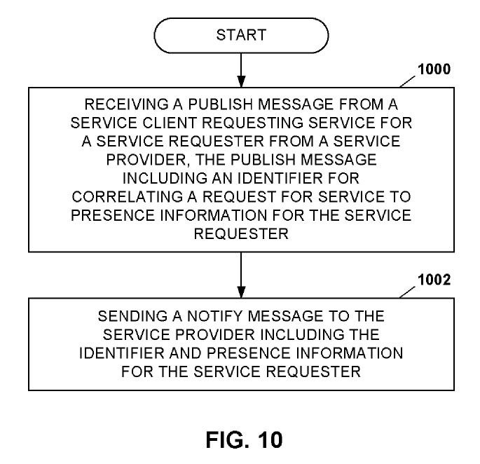

FIG. 10 is a flow diagram illustrating a method at a presence service for verifying an identity of a service requester using presence information according to another aspect of the subject matter disclosed. In block 1000, a publish message is received from the service client 100 requesting service for a service requester from the service provider 102. The publish message includes an identifier for correlating a request for service to presence information for the service requester. In block 1002, a notify message is sent to the service provider including the identifier and presence information for the service requester.

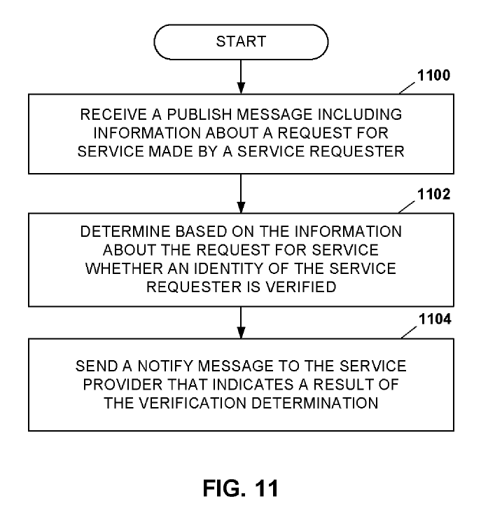

FIG. 11 is a flow diagram illustrating a method at a presence service for verifying an identity of a service requester using presence information according to another aspect of the subject matter disclosed. In block 1100, a publish message including information about a request for service made by a service requester is received. The presence service 104 determines, based on the information about the request for service, whether an identity of the service requester is verified in block 1102. For example, the presence service 104 can compare the information about the request for service to presence information associated with the service requester, and determine, based on the comparison, whether an identity of the service requester is verified.

According to another aspect, the presence service 104 can send a notify message to a service client 100 associated with the service requester that includes the information about the request for service and receive a publish message from the service client that indicates whether an identity of the service requester is verified.

According to another aspect, the information about the request for service can include, for example, information about a location associated with the request for service and/or information about an activity associated with the request for service. According to yet another aspect, the information about the request for service can include a certificate verifying an identity of the service provider to the presence service. According to still another aspect, the presence information associated with the service requester can include information about a location associated with the service requester and/or information about an activity associated with the service requester.

A notify message is sent to the service provider 102 that indicates a result of the verification determination in block 1104. The service provider 102 processes the notify message to determine verification.

Exemplary Scenarios

Scenario 1: Buy a Book at Local Bookstore

1. Larry provides a credit card to a bookstore for some items.
2. The store clerk receives authorization from the credit card company.
3. The store has the URL of the presence tuple of the card holder (service requester) in its account database since he or she has shopped there before.
4. The store's account system automatically matches the presence information in the user's tuple against the activity of shopping in the store's location.
5. The tuple indicates the card owner's activity status is “watching TV”.
6. The clerk keeps the card and calls store security.
   Scenario 2: Arriving at Work
1. Larry arrives at work and slides his badge into the badge reader.
2. The badge reader checks the ID on the badge against its database and authorizes entrance.
3. The security system has a subscription to all its employee's presence status from the time a badge is swiped in the morning until the employee swipes it again on the way out.
4. The security system determines that Larry's location according to his presence tuple is the current worksite.
5. The lock on the door is released.
   Scenario 3: Online Request for Service
1. Larry logs into a bank account at MyTown Bank.
2. He initiates a transaction to transfer money to an account in another bank.
3. His browser is set to send a notify message to a watcher associated with the URL the request was sent to. A naming convention is used to map the bank URL to the bank watcher's presence URL.
4. The presence service sends Larry's presence tuple to MyTown Bank.
5. The data in the presence tuple is a match for the request but the tuples URL does not match the presence URL of the account owner of the account Larry is using.
6. The request is denied.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for verifying an identity of a service requester using presence information, the method comprising:
at a service provider:
receiving a request for service from a service requester via a service client, the request including an identifier for identifying presence information for the service requester; and
communicating with a presence service associated with the identified presence information for verifying an identity of the service requester based on the presence information.

2. The method of claim 1 wherein the identifier identifying presence information includes a uniform resource indicator (URI).

3. The method of claim 1 wherein communicating with a presence service associated with the identified presence information for verifying an identity of the service requester comprises:
subscribing to a presence tuple associated with the service requester;
receiving at least one notification message including presence information for the service requester; and
processing the at least one notification message to verify an identity of the service requester based on the presence information.

4. The method of claim 1 wherein communicating with a presence service associated with the identified presence information for verifying an identity of the service requester comprises:
receiving at least one notification message including presence information for the service requester and the identifier;
correlating the at least one notification message to the request for service based on the identifier; and
processing the at least one notification message to verify an identity of the service requester based on the received presence information.

5. The method of claim 1 wherein communicating with a presence service associated with the identified presence information for verifying an identity of the service requester comprises:
publishing information about the request for service to the presence service;
receiving at least one notification message indicating whether the identity of the service requester is verified; and
processing the at least one notification message to verify an identity of the service requester based on the received indication.

6. The method of claim 5 wherein the information about the request for service includes at least one of information about a location associated with the request for service and information about an activity associated with the request for service.

7. The method of claim 1 wherein communicating with a presence service associated with the identified presence information for verifying an identity of the service requester includes providing a certificate verifying an identity of the service provider to the presence service.

8. A method for verifying an identity of a service requester using presence information, the method comprising:
at a presence service:
receiving a subscribe message from a service provider for subscribing to presence information for a service requester;
sending a notify message to a service client associated with the service requester, the notify message indicating that the subscribe message has been received;
receiving a publish message from the service client, the publish message indicating an authorization for providing the presence information to the service provider;
determining whether to send a notify message including the presence information to the service provider based on the indicated authorization; and
sending the notify message based on the determination.

9. A method for verifying an identity of a service requester using presence information, the method comprising:
at a presence service:
receiving a publish message from a service client requesting service for a service requester from a service provider, the publish message including an identifier for correlating a request for service to presence information for the service requester; and
sending a notify message to the service provider including the identifier and presence information for the service requester.

10. A method for verifying an identity of a service requester using presence information, the method comprising:
at a presence service:
receiving a publish message including information about a request for service made by a service requester;
determining, based on the information about the request for service, whether an identity of the service requester is verified; and
sending a notify message to the service provider that indicates a result of the verification determination.

11. The method of claim 10 wherein determining whether an identity of the service requester is verified comprises:
comparing the information about the request for service to presence information associated with the service requester; and
determining, based on the comparison, whether an identity of the service requester is verified.

12. The method of claim 10, wherein determining whether an identity of the service requester is verified comprises:
sending a notify message to a service client associated with the service requester, the notify message including the information about the request for service; and
receiving a publish message from the service client, the publish message indicating whether an identity of the service requester is verified.

13. The method of claim 10 wherein the information about the request for service includes at least one of information about a location associated with the request for service and information about an activity associated with the request for service.

14. The method of claim 10 wherein the information about the request for service includes a certificate verifying an identity of the service provider to the presence service.

15. The method of claim 11 wherein the presence information associated with the service requester includes at least one of information about a location associated with the service requester and information about an activity associated with the service requester.

16. A computer program product comprising computer executable instructions embodied in a computer-readable medium for performing steps comprising:
receiving a request for service from a service requester via a service client, the request including an identifier for identifying presence information for the service requester; and
communicating with a presence service associated with the identified presence information for verifying an identity of the service requester based on the presence information.

17. A computer program product comprising computer executable instructions embodied in a computer-readable medium for performing steps comprising:
receiving a subscribe message from a service provider for subscribing to presence information for a service requester;
sending a notify message to a service client associated with the service requester, the notify message indicating that the subscribe message has been received;
receiving a publish message from the service client, the publish message indicating an authorization for providing the presence information to the service provider;
determining whether to send a notify message including the presence information to the service provider based on the indicated authorization; and
sending the notify message based on the determination.

18. A computer program product comprising computer executable instructions embodied in a computer-readable medium for performing steps comprising:
receiving a publish message from a service client requesting service for a service requester from a service provider, the publish message including an identifier for correlating a request for service to presence information for the service requester; and
sending a notify message to the service provider including the identifier and presence information for the service requester.

19. A computer program product comprising computer executable instructions embodied in a computer-readable medium for performing steps comprising:
receiving a publish message including information about a request for service made by a service requester;
determining, based on the information about the request for service, whether an identity of the service requester is verified; and
sending a notify message to the service provider that indicates a result of the verification determination.

20. A system for verifying, at a service provider, an identity of a service requester using presence information, the system comprising:
means for communicating with a service client and with a presence service;
means for processing a request for service received from a service requester via the service client, the request including an identifier for identifying presence information for the service requester; and
means for communicating with a presence service associated with the identified presence information for verifying an identity of the service requester based on the presence information.

21. A system for verifying, at a service provider, an identity of a service requester using presence information, the system comprising:
a network interface configured for communicating with a service client and with a presence service;
a service client interface component configured for processing a request for service received from a service requester via the service client, the request including an identifier for identifying presence information for the service requester; and
a presence verification component configured for communicating with a presence service associated with the identified presence information for verifying an identity of the service requester based on the presence information.

22. The system of claim 21 wherein the identifier identifying presence information includes a URI.

23. The system of claim 21 wherein the presence verification component is configured to communicate with a presence service associated with the identified presence information for verifying an identity of the service requester by:
subscribing to a presence tuple associated with the service requester;
receiving at least one notification message including presence information for the service requester; and
processing the at least one notification message to verify an identity of the service requester based on the presence information.

24. The system of claim 21 wherein the presence verification component is configured to communicate with a presence service associated with the identified presence information for verifying an identity of the service requester by:
receiving at least one notification message including presence information for the service requester and the identifier;
correlating the at least one notification message to the request for service based on the identifier; and
processing the at least one notification message to verify an identity of the service requester based on the received presence information.

25. The system of claim 21 wherein the presence verification component is configured to communicate with a presence service associated with the identified presence information for verifying an identity of the service requester by:
publishing information about the request for service to the presence service;
receiving at least one notification message indicating whether the identity of the service requester is verified; and
processing the at least one notification message to verify an identity of the service requester based on the received indication.

26. The system of claim 25 wherein the information about the request for service includes at least one of information about a location associated with the request for service and information about an activity associated with the request for service.

27. The system of claim 25 wherein the information about the request for service includes a certificate verifying an identity of the service provider to the presence service.

28. A system for verifying an identity of a service requester using presence information at a presence service, the system comprising:
means for communicating with a service client and with a service provider;
means for processing a subscribe message from the service provider for subscribing to presence information for a service requester associated with the service client, for sending a notify message to notify the service client that the subscribe message has been received, for receiving a publish message from the service client that indicates an authorization for providing the presence information to the service provider, and for sending a corresponding notify message with the presence information to the service provider; and
means for processing the received publish message to determine whether to send the notify message with the presence information to the service provider based on the indicated authorization.

29. A system for verifying an identity of a service requester using presence information at a presence service, the system comprising:
a network interface configured for communicating with a service client and with a service provider;
a notification component configured for processing a subscribe message from the service provider for subscribing to presence information for a service requester associated with the service client, for sending a notify message to notify the service client that the subscribe message has been received, for receiving a publish message from the service client that indicates an authorization for providing the presence information to the service provider, and for sending a corresponding notify message with the presence information to the service provider; and
a verification component configured for processing the received publish message to determine whether to send the notify message with the presence information to the service provider based on the indicated authorization.

30. A system for verifying an identity of a service requester using presence information at a presence service, the system comprising:
means for communicating with a service client and with a service provider;
means for receiving a publish message from the service client, the publish message including an identifier for correlating a request for service to presence information for a service requester; and
means for sending a notify message to the service provider including the identifier and presence information for the service requester.

31. A system for verifying an identity of a service requester using presence information at a presence service, the system comprising:
a network interface configured for communicating with a service client and with a service provider;
a publish component configured for receiving a publish message from the service client, the publish message including an identifier for correlating a request for service to presence information for the service requester; and
a notification component configured for sending a notify message to the service provider including the identifier and presence information for the service requester.

32. A system for verifying an identity of a service requester using presence information at a presence service, the system comprising:
means for communicating with a service client and with a service provider;
means for processing a publish message received from the service provider that includes information about a request for service made by a service requester and for sending a corresponding notify message to the service provider with a verification indication; and
means for determining the verification indication based on the information about the request for service, the verification indication indicating whether an identity of the service requester is verified.

33. A system for verifying an identity of a service requester using presence information at a presence service, the system comprising:
a network interface configured for communicating with a service client and with a service provider;
a publish component configured for processing a publish message received from the service provider that includes information about a request for service made by a service requester and for sending a corresponding notify message to the service provider with a verification indication; and
a verification component configured for determining the verification indication based on the information about the request for service, the verification indication indicating whether an identity of the service requester is verified.

34. The system of claim 33 wherein the verification component is configure to:
compare the information about the request for service to presence information associated with the service requester; and
determine, based on the comparison, whether an identity of the service requester is verified.

35. The system of claim 33 wherein the verification component is configure to:
sending a notify message to a service client associated with the service requester, the notify message including the information about the request for service; and
receiving a publish message from the service client, the publish message indicating whether an identity of the service requester is verified.

36. The system of claim 33 wherein the information about the request for service includes at least one of information about a location associated with the request for service and information about an activity associated with the request for service.

37. The system of claim 33 wherein the information about the request for service includes a certificate verifying an identity of the service provider to the presence service.

38. The system of claim 34 wherein the presence information associated with the service requester includes at least one of information about a location associated with the service requester and information about an activity associated with the service requester.
